(19) United States
(12) Patent Application Publication
(10) Pub. No.: US 2012/0144931 A1
(43) Pub. Date: Jun. 14, 2012

(54) PRESSURE-MEASURING PROBE

(75) Inventor: Armin Michel, Bergkirchen (DE)

(73) Assignee: MTU AERO ENGINES GMBH, Munchen (DE)

(21) Appl. No.: 13/390,908

(22) PCT Filed: Aug. 5, 2010
(86) PCT No.: PCT/DE2010/000928

§ 371 Date: Feb. 16, 2012

(30) Foreign Application Priority Data
Aug. 18, 2009 (DE) 10 2009 037 957.6

(51) Int. Cl. G01F 1/34

(52) U.S. Cl. 73/861.42

(57) ABSTRACT

The invention relates to a pressure-measuring probe (1) for measuring pressure values of a flow, in particular a supersonic flow, comprising at least one probe head (2) which has a probe surface (8) provided with pressure-measuring points (4,6) and which can be positioned in the flow by means of at least one probe shaft (10). According to the invention, a top side (12) of the probe head (2) and the bottom side (14) of the probe head define a wedge-shaped probe tip (16), wherein pressure-measuring points (4) are arranged at a distance from each other along the circumferential probe tip (16).

### CROSS-REFERENCE TO RELATED APPLICATIONS

This application is a U.S. National Phase application submitted under 35 U.S.C. §371 of Patent Cooperation Treaty application serial no. PCT/DE2010/000928, filed Aug. 5, 2010, and entitled PRESSURE-MEASURING PROBE, which application claims priority to German patent application serial no. 10 2009 037 957.6, filed Aug. 18, 2009, and entitled DRUCKMESSSONDE.

Patent Cooperation Treaty application serial no. PCT/DE2010/000928, published as WO 2011/020459, and German patent application serial no. 10 2009 037 957.6, are incorporated herein by reference.

### TECHNICAL FIELD

The invention relates to a pressure-measuring probe for measuring pressure values of a flow, and more specifically to a pressure-measuring probe for measuring pressure values of a flow including a supersonic flow.

### BACKGROUND

Pressure-measuring probes are known for measuring pressure values of a flow. Such pressure-measuring probes are used for measuring the directional components, of the total pressure and/or the static pressure of a flow inside of a gas turbine, for example, in particular in the area of the compressor of an aero gas turbine. Compressors generally have a stability limit which depends on their performance curve. If this stability limit is exceeded unintentionally during the operation of the compressor, for example through an inlet disturbance, temperature changes, or contamination, then strong transient flows (revolving breakdown, surging) occur, which can rapidly lead to the destruction of the turbo-machine. For that reason, it is customary to provide a sufficient distance between the working line of the compressor and the stability limit, wherein all disturbances are taken into account as a margin of safety, which could reduce the surge limit distance. But by having a fixed safety margin, however, a substantial operating range of the compressor with good efficiency is lost.

To still further increase the efficiency and/or the power density of modern turbo machines, it was considered how compressors can be operated safely close to the stability limit. For this purpose, it is necessary to measure the return flow profiles during surging in compressors in order to investigate the physical functionality of the flow during surging. During the surging of compressors, the flow flows through the compressor from the back to the front. In this context, the directional flow varies in an angular range of up to 270°, wherein the Mach number increases from subsonic to supersonic.

In order to determine in addition to the pressure values also the directional components of a flow, multiple hole probes with spatially distributed measuring holes are known from the general prior art, which are designed as spherical or hemispherical head probes with measuring holes which are arranged on meridians standing perpendicular to each other. By using calibration diagrams, it is possible to determine the swing angle, the tilt angle, and the amount of the flow velocity from the pressure differences at the measuring hole locations. By using these values, it is possible to split up the velocity vector of a turbo machine into the peripheral, radial, and axial components. Because of the compression shock wave that occurs, performing measurements with such measuring probes in the supersonic area is not possible, however.

A pressure-measuring probe for measuring the relative velocity of a medium flowing in the supersonic area is known from DE 39 23 753 A1, wherein the probe body has a probe head in the form of a wedge or a cone, the largest diameter of which is larger than the outside diameter of the probe shaft. A disadvantage of such pressure-measuring probes is that in particular the flow that flows during the surging of compressors from the back to the front through the compressor cannot be sensed.

### SUMMARY AND DESCRIPTION

One object of the invention is creating a pressure-measuring probe that makes it possible to measure pressure at different flow conditions in the subsonic and supersonic range.

This object is solved by a pressure-measuring probe with the features described and claimed herein.

According to a first embodiment of the invention, the pressure-measuring probe or the directional probe is provided for the measurement of pressure values of a flow, in particular of a supersonic flow, and has at least a probe head that has a probe surface provided with pressure-measuring points and which can be positioned in the flow by means of at least one probe shaft. According to the embodiment, a top side of the probe head with its bottom side defines a wedge-shaped probe tip, wherein pressure-measuring points are arranged at a distance from each other along the circumferential probe tip. In contrast to the state-of-the-art, due to the circumferential, wedge-shaped probe tip, the measurement of pressure values (total pressure values and static pressure values) of a subsonic and supersonic flow is possible. The pressure-measuring points which are arranged circumferentially at a distance to each other along the probe tip facilitate a 360° sensing of flows in different flow directions, so that it is particularly possible to perform a flow analysis of compressors in the range of the surging. The backflow phenomena during surging can be investigated. This enables for better prediction of the loads on the compressor blades during surging. The probe can be calibrated in a supersonic wind tunnel similar to a 5-hole probe.

In a particularly preferred embodiment of the invention, the pressure-measuring probe has a rotationally symmetric probe head. In this context it has proven to be particularly advantageous if the probe head is discus-shaped.

A top side of the probe head preferably includes a tip angle α in the range of approximately 10 to 40°, preferably from approximately 20 to 30°, with the bottom side of the probe head.

The probe head is preferably designed symmetrically relative to a tip plane extending through the tip.

According to further embodiments of the invention, pressure-measuring points can be provided in the area of the probe tip as measuring points for total pressure (total pressure discharge port, total pressure hole). In this context it has been found advantageous if at least eight measuring points for total pressure are arranged in the area of the tip of the probe head. Due to the measuring points for total pressure that are arranged circumferentially along the probe tip, they are spaced relatively far apart, so that a high measuring accuracy is achieved. The pressure-measuring points which are arranged circumferentially spaced apart to each other along the probe tip facilitate a 360° sensing of total pressure values of a flow with different flow direction.

In an actual embodiment, the pressure-measuring points are provided for the determination of static pressure values in the area of the top side and/or the bottom side of the probe head.

Preferably at least eight pressure-measuring points are provided respectively for the determination of the static pressure in the area of the top side and the bottom side of the probe head.

According to still further aspects of the invention, it was found to be advantageous if a longitudinal axis of the probe shaft extends approximately at right angles to a tip plane of the probe head. Pursuant to an embodiment of the pressure-measuring probe, the probe shaft attaches approximately centrally in the area of a longitudinal axis of the probe head. In this way, the flow to be measured is affected as little as possible by the probe shaft.

In an embodiment according to the invention, the probe shaft has a constriction in the contact area at the probe head which is shaped such that the diameter of the probe shaft is reduced in the direction of the probe head.

Probe head shaft and probe shaft preferably have pressure-measuring lines connecting the pressure-measuring points with pressure sensors. These can be designed as bores. Preferably at least one pressure-measuring line is provided per pressure-measuring point. With this solution, the pressure sensors can be arranged outside of the measuring room, so that an extremely compact pressure-measuring sensor is accomplished, the probe head of which has a minimal effect on the flow.

Alternatively, a pressure sensor can be respectively assigned to the pressure-measuring points directly or indirectly at the measuring position. Due to the short detection paths, a rapid and highly accurate measured data acquisition is accomplished overall.

Preferably, one pressure sensor is respectively assigned to the pressure measuring points, so that the measuring points can be measured independently of each other and the flow can correspondingly be analyzed extremely accurately.

Miscellaneous advantageous refinements of the invention are part of the further sub-claims.

### BRIEF DESCRIPTION OF THE DRAWINGS

A preferred embodiment of the invention is explained in detail by means of schematic drawings in the following, as follows:

FIG. 1 is a side elevation of a pressure-measuring probe according to the invention, and

FIG. 2 is a horizontal projection of the pressure-measuring probe from FIG. 1.

### DETAILED DESCRIPTION

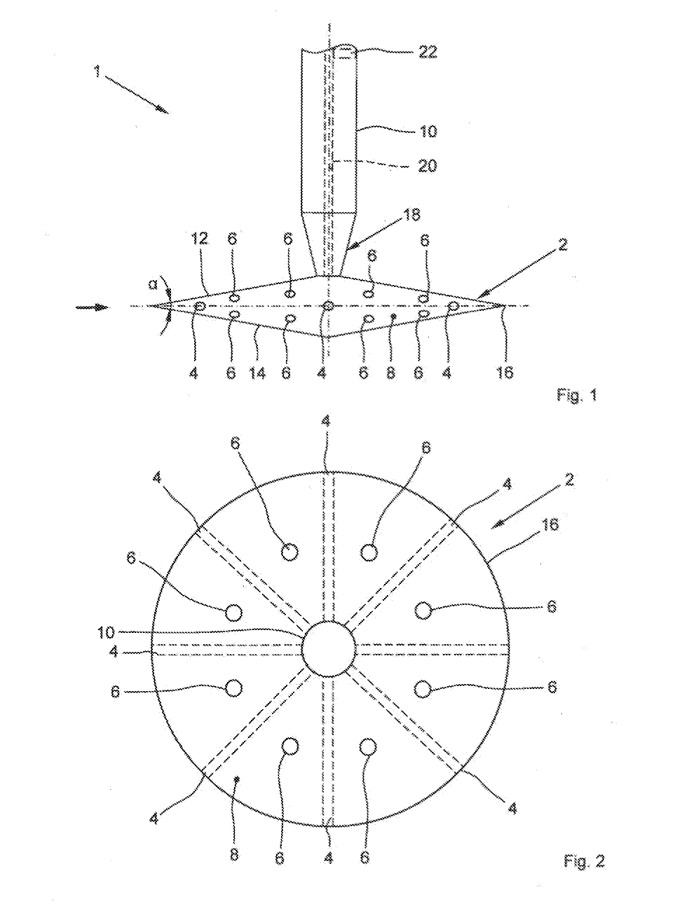

FIG. 1 shows a pressure-measuring probe 1 according to the invention for analyzing spatial supersonic flows in the area of the compressor of an aero gas turbine. The pressure-measuring probe 1 has a probe head 2, which has a probe surface 8 provided with points for measuring total pressure 4 (total pressure bores) and static pressure-measuring points 6 and which can be positioned in the flow by means of a probe shaft 10. According to the invention, a top side 12 of the probe head 2 with its bottom side 14 defines a wedge-shaped probe tip 16, wherein the total pressure-measuring points 4 are arranged at a distance from each other along the circumferential probe tip 16. The probe head 2 is designed rotationally symmetric, essentially discus-shaped, wherein the top side 12 of the probe head 2 includes a tip angle α of approximately 25° with the bottom side 14 of the probe head 2. The probe head 2 is preferably designed symmetrically relative to a tip plane extending through the tip 16. Because of the circumferential wedge-shaped designed probe head 2, it makes the measurement of pressure values (total pressure values and static pressure values) of a supersonic flow possible. The circumferentially arranged pressure-measuring points 4, 6, facilitate the detection of flows of different flow direction, so that an analysis of the compressor is possible in the limit range of the surging. The main flow direction in FIG. 1 is indicated by an arrow.

The longitudinal axis of the probe shaft 10 extends approximately at right angles to the tip plane of the probe head 2, wherein the probe shaft 10 attaches approximately in the center area of the longitudinal axis of the probe head 2. The probe shaft 10 is provided with a constriction 18 in the contact area at the probe head 2, which is designed such that the diameter of the probe shaft 10 is reduced frusto-conically in the range of approximately 8 to 10 mm in direction of the probe head 2. In this way, the flow to be measured is affected as little as possible by the probe shaft 10.

The probe head shaft and the probe shaft 2, 10, have pressure-measuring lines 20 designed as a bore system for connecting the pressure-measuring points 4, 6, with schematically indicated pressure sensors 22. One pressure-measuring line 20 is assigned to each pressure-measuring point 4, 6. With this solution, the pressure sensors 22 are arranged outside of the measuring room, so that an extremely compact pressure-measuring sensor 1 is accomplished, the probe head 2 of which has a minimal effect on the flow. Preferably, one pressure sensor 22 is respectively assigned to the pressure points 4, 6, so that the measuring points can be measured independently of each other and the flow can correspondingly be analyzed extremely accurately.

In an alternative embodiment of the invention (not shown), the pressure sensors are respectively arranged directly or indirectly on the pressure-measuring points 4, 6.

As can be seen especially in FIG. 2, which shows a horizontal projection of the pressure-measuring probe 1 from FIG. 1, eight total pressure-measuring points 4 are arranged reciprocally offset by 45° along the probe tip 16 of the probe head 2. The pressure-measuring points which are arranged circumferentially spaced apart to each other along the probe tip 16 facilitate a 360° sensing of total pressure values of the flow at different flow direction.

In order to determine the static pressure values, eight static measuring points are respectively provided in the area of the top side to 12 and the bottom side 14 of the probe head 2, which are arranged offset by 45° to each other in each case. The static measuring points 6 respectively terminate between the total pressure-measuring points 4 in the probe surface 8, so that a bore system is formed, which facilitates a compact probe head 2.

Altogether, due to the discus-shaped probe head 2 and the arrangement of the pressure-measuring points 4, 6, this achieves a pressure-measuring probe 1 with an excellent, spatial resolution, which provides reliable measuring results even in intensive transient flow fields with strong gradients as well as in the supersonic range.

Disclosed is a pressure-measuring probe 1 for measuring pressure values of a flow, in particular a supersonic flow, comprising at least one probe head 2 which has a probe surface 8 provided with pressure-measuring points 4, 6, and which can be positioned in the flow by means of at least one probe shaft 10. According to the invention, a top side 12 of the probe head 2 with its bottom side 14 defines a wedge-shaped probe tip 16, wherein pressure-measuring points 4 are arranged at a distance from each other along the circumferential probe tip 16.

1-14. (canceled)

15. A pressure-measuring probe for measuring pressure values of a flow, in particular a supersonic flow, the probe comprising:
at least one probe head configured in the shape of a rotationally symmetric discus having a probe surface with a top side and a bottom side;
at least one probe shaft connected to the probe head so as to position the probe head in a flow;
wherein the top side of the probe head with the bottom side defines a circumferential, wedge-shaped probe tip; and
a plurality of pressure-measuring points, the pressure-measuring points being arranged at a distance from each other along the circumferential probe tip.

16. A pressure-measuring probe according to claim 15, wherein the top side of the probe head defines with the bottom side a tip angle α in a range of approximately 10 degrees to 40 degrees.

17. A pressure-measuring probe according to claim 16, wherein the top side of the probe head defines with the bottom side a tip angle α in a range of approximately 20 degrees to 30 degrees.

18. A pressure-measuring probe according to claim 15, wherein the probe head is configured symmetrical relative to a tip plane that extends through the circumferential probe tip.

19. A pressure-measuring probe according to claim 15, wherein the pressure-measuring points in the area of the probe tip are total pressure measuring points.

20. A pressure-measuring probe according to claim 19, wherein at least eight total pressure measuring points are disposed in the area of the probe tip of the probe head.

21. A pressure-measuring probe according to claim 15, further comprising a plurality of pressure-measuring points in the area of the top side and/or the bottom side of the probe head, the pressure-measuring points in the area of the top side and/or the bottom side of the probe head being static pressure measuring points for the determination of static pressure values.

22. A pressure-measuring probe according to claim 21, wherein at least eight static pressure measuring points are provided.

23. A pressure-measuring probe according to claim 15, wherein the probe shaft defines a longitudinal axis extending approximately at right angles to a tip plane that extends through the circumferential probe tip of the probe head.

24. A pressure-measuring probe according to claim 15, wherein the probe shaft attaches approximately in the center of an area of a longitudinal axis of the probe head.

25. A pressure-measuring probe according to claim 15, wherein the probe shaft is configured with a constriction in an area proximate to the probe head, such that the diameter of the probe shaft is reduced in the direction of the probe head.

26. A pressure-measuring probe according to claim 15, further comprising:
a plurality of pressure-measuring lines disposed within the probe head and the probe shaft; and
a plurality of pressure sensors;
wherein the pressure-measuring lines connect the pressure-measuring points to the pressure sensors.

27. A pressure-measuring probe according to claim 15, further comprising:
a plurality of pressure sensors, each respective pressure sensor being arranged directly or indirectly at a respective measuring location; and
each respective pressure-measuring point being respectively assigned a pressure sensor.

28. A pressure-measuring probe according to claim 15, further comprising a plurality of pressure sensors, wherein one pressure sensor is respectively provided per pressure-measuring point.

29. A pressure-measuring probe for measuring pressure values of a flow, in particular a supersonic flow, the probe comprising:
at least one probe head configured in the shape of a rotationally symmetric discus having a rotational symmetry axis, a longitudinal axis oriented substantially perpendicular to the rotational symmetry axis and a probe surface with a top side and a bottom side;
the top side of the probe head with the bottom side defining a circumferential, wedge-shaped probe tip;
at least one probe shaft connected to the probe head so as to position the probe head in a flow having a main flow direction such that the longitudinal axis of the probe head is aligned with the main flow direction;
a plurality of first pressure-measuring points, the first pressure-measuring points being arranged at a distance from each other along the circumferential probe tip, each respective first pressure-measuring point being configured for measuring a respective total pressure at the respective first pressure-measuring point; and
a plurality of second pressure-measuring points, the second pressure-measuring points being arranged at a distance from one another on at least one of the top side and the bottom side of the probe head, each respective second pressure-measuring point being configured for measuring a respective static pressure at the respective second pressure-measuring point.

30. A pressure-measuring probe according to claim 29, wherein the top side of the probe head with the bottom side defines a tip angle α in a range of approximately 10 degrees to 40 degrees.

31. A pressure-measuring probe according to claim 30, wherein the top side of the probe head with the bottom side defines a tip angle α in a range of approximately 20 degrees to 30 degrees.

32. A pressure-measuring probe according to claim 29, wherein at least eight first pressure-measuring points are substantially equally spaced from one another along the circumferential probe tip of the probe head.

33. A pressure-measuring probe according to claim 29, wherein the probe shaft is attached to the probe head at substantially the center of the longitudinal axis of the probe head.

34. A pressure-measuring probe according to claim 29, further comprising a plurality of pressure sensors, wherein a respective one of the plurality of pressure sensor is operatively connected to each respective pressure-measuring point of the probe head.
